(19) United States
(12) Patent Application Publication
(10) Pub. No.: US 2019/0370954 A1
(43) Pub. Date: Dec. 5, 2019

(54) MEASUREMENT INFORMATION INTEGRATING DEVICE AND PROGRAM

(71) Applicant: Mitutoyo Corporation, Kawasaki (JP)

(72) Inventor: Shinsaku Abe, Iwamizawa (JP)

(21) Appl. No.: 16/416,900

(22) Filed: May 20, 2019

(30) Foreign Application Priority Data
Jun. 4, 2018 (JP) 2018-106872

(51) Int. Cl. G06T 7/00; G06F 17/50; G06T 7/60

(52) U.S. Cl. CPC G06T 7/0004; G06T 7/60; G06F 17/5086

(57) ABSTRACT

A measurement information integrating device includes an imaging unit that captures an image including a target object with a measuring device and the measuring device on which a measured value of the target object is displayed; a measured value reading unit that reads the measured value from an image captured by the imaging unit; a display unit; a display control unit that superimposes the measured value and predetermined information associated with the measured value on a periphery of the target object and the measuring device present in the captured image and to cause the display unit to display a superimposed image; and an integrated data generating unit that captures an image displayed on the display unit to generate image data and to extract a predetermined portion of the predetermined information as extended information to generate integrated data in which the extended information is added to the image data.

### TECHNICAL FIELD

The present invention relates to a measurement information integrating device and a program configured to generate data in which a measured value and information associate with the measured value are integrated.

### BACKGROUND ART

In a case where a target object is measured with a measuring device, information associated with the measurement is often managed together with the measured value to evaluate validity of the measurement, perform post-comparison of measurement results, or the like.

Examples of the associated information managed together with the measured value include measurement date and time; a measurer; used equipment; a target object and a measurement portion; and a design value, a specification value, and acceptability to the design value and the specification value.

The associated information is generally managed on the basis of a file name and in association with the measured value or managed by using general-purpose software such as spreadsheet software and a relational database, dedicated software, or the like.

### SUMMARY OF INVENTION

### Technical Problem

In a case where the associated information is managed on the basis of a file name, a file storage method and a file naming rule are necessary, and it is necessary for a user to have skill to perform a search under the file naming rule. In addition, in the case of a management method using software, the following problems arise. It is necessary to start the software to read management information. When software includes a simple configuration, a technique for managing and searching for information is necessary, and the cost is high for user-friendly software.

An object of the invention is to provide a measurement information integrating device and a program enabling a measured value and information associated with the measured value to be easily read and also enabling information to be easily accessed.

### Solution to Problem

A measurement information integrating device according to an aspect of the invention includes an imaging unit configured to capture an image including a target object during measurement with a measuring device and the measuring device on which a measured value of the target object is displayed, a measured value reading unit configured to read the measured value from a captured image captured by the imaging unit, a display unit, a display control unit configured to superimpose the measured value and predetermined information associated with the measured value on a periphery of the target object and the measuring device present in the captured image and to cause the display unit to display a superimposed image; and an integrated data generating unit configured to capture an image displayed on the display unit to generate image data and to extract a predetermined portion of the predetermined information as extended information to generate integrated data in which the extended information is added to the image data.

A measurement information integrating device according to an aspect of the invention may be configured such that the display unit faces the eyes of a wearer in a case that the measurement information integrating device is mounted on a head, and a range of an image captured by the imaging unit changes depending on movement of a body of the wearer.

A function of each unit described above may be realized by describing the function in a program and causing a computer to execute the program.

### Advantageous Effects of Invention

According to the measurement information integrating device of the invention, the integrated data including the image data in which the measured value and the information associated with the measured value can be read simultaneously, and the extended information can be generated easily. Accordingly, the measured value in the measurement and the information associated with the measured value can be read easily only by extraction of the integrated data related to the measurement of the target object. In addition, since each piece of the integrated data includes the extended information related to each measurement, information can be accessed and analyzed easily. Further, since the configuration is simple, the measurement information integrating device can be realized at a low cost.

### BRIEF DESCRIPTION OF DRAWINGS

FIG. 1 is a functional block diagram of a measurement information integrating device of the invention.

FIG. 2 is a view illustrating an example of a captured image captured by an imaging unit.

FIG. 3 is a view illustrating a display example of a captured image, a measured value, and predetermined information on a display unit.

FIG. 4 is a view illustrating another example of a captured image captured by an imaging unit.

FIG. 5 is a view illustrating another display example of a captured image, a measured value, and predetermined information on a display unit.

FIG. 6 is a view illustrating an example of a configuration of a measurement information integrating device 100 according to the invention in which a function of each unit is realized by causing a CPU to execute a program in which the function of each unit is described.

### DESCRIPTION OF EMBODIMENTS

Embodiments of the invention will be described hereinafter with reference to the drawings. Note that in the following description, the same portions are denoted by the same reference signs, and a description of the portions that have already been described will be omitted appropriately.

### First Embodiment

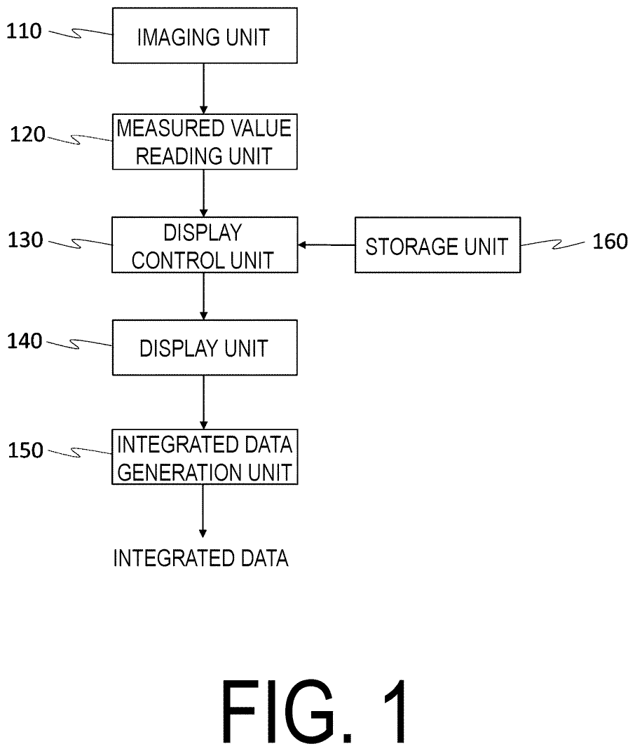

FIG. 1 is a functional block diagram of a measurement information integrating device 100 of the invention. The measurement information integrating device 100 includes an imaging unit 110, a measured value reading unit 120, a display control unit 130, a display unit 140, and an integrated data generating unit 150.

The imaging unit 110 captures an image including a target object during measurement with a measuring device and the measuring device on which a measured value of the target object is displayed.

The measured value reading unit 120 reads the measured value from a captured image captured by the imaging unit 110. The measured value may be read from an image by using any technique (for example, a technique disclosed in JP 2016-186439 A).

The display control unit 130 causes the display unit 140 to display a captured image. At this time, the display control unit 130 causes the display unit 140 to display a superimposed image in which the measured value read by the measured value read unit 120 and the predetermined information associated with the measured value are superimposed on a periphery of the target object and the measuring device present in the captured image.

Examples of the information associated with the measured value include measurement date and time; a measurer; used equipment; a target object and a measurement portion; and a design value, a specification value, and acceptability to the design value and the specification value. The display control unit 130 causes the display unit 140 to display, as predetermined information, some information appropriately selected from among such various pieces of associated information.

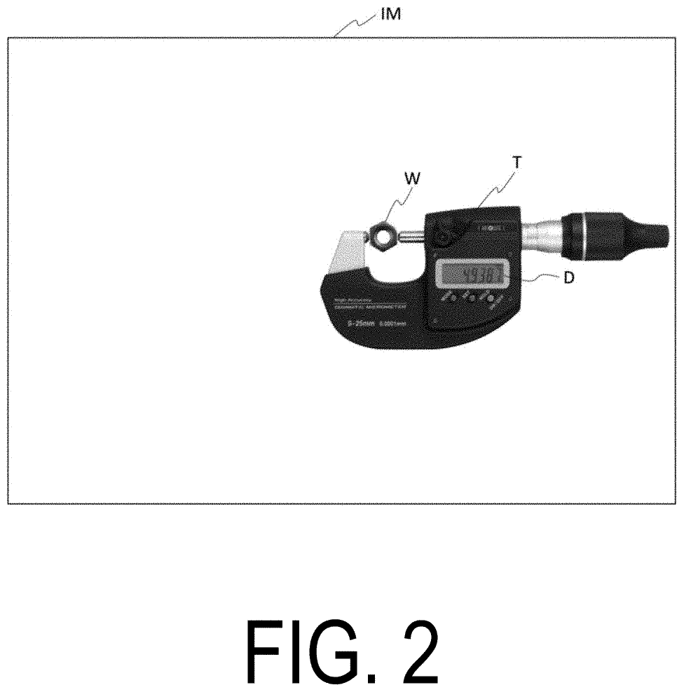

An example of a captured image IM captured by the imaging unit 110 is illustrated in FIG. 2. In this example, in the captured image IM, a target object W is set in a measuring device T, and a measured value is displayed on a measured value display unit D of the measuring device T.

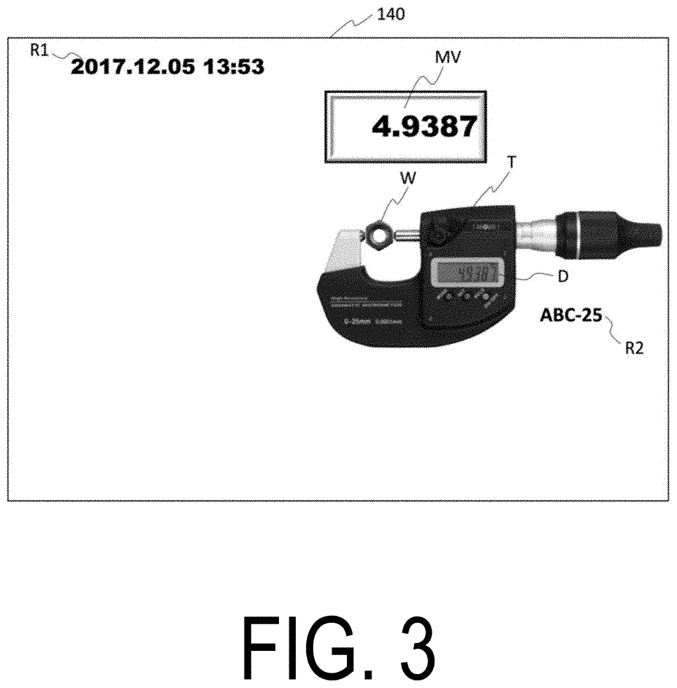

FIG. 3 is a view illustrating an example in which a measured value MV; and measurement date and time information R1 and model information R2 which are predetermined information are superimposed on a periphery of the target object W and the measuring device T in the captured image IM, and a superimposed image is displayed on the display unit 140.

The display control unit 130 can obtain the measurement date and time information R1 by using a clock function in a case where the measurement information integrating device 100 is realized by a computer including the clock function, for example.

The model information R2 is information representing a type of the measuring device T. A method for identifying a type of the measuring device T is any method. For example, images or CAD models of a plurality of types of measuring devices are prepared in advance in a storage unit 160, the images or the CAD models are checked against an image of the measuring device T, and the type of the measuring device T can be identified from commonality of features and the like.

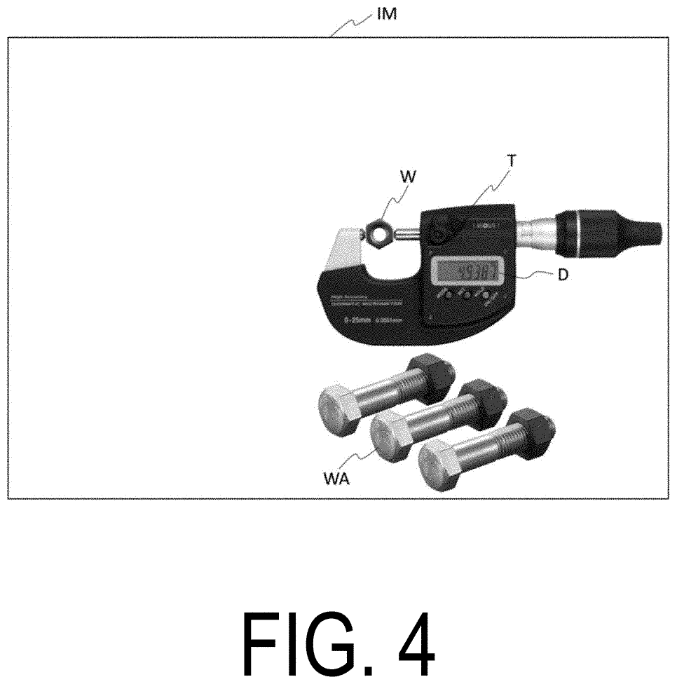

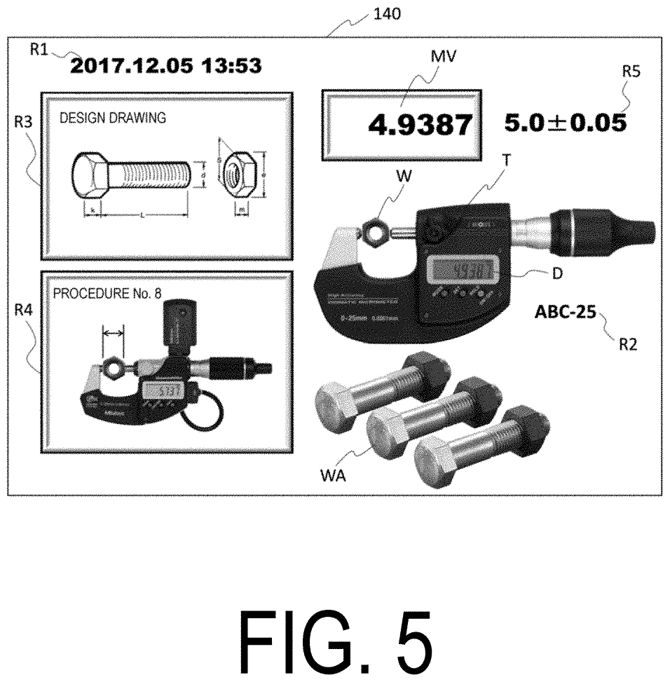

In a case where the target object W is a portion of an article WA (for example, the target object W is a nut, and the article WA is a bolt and nut set), an image of the measuring device T and the target object W are captured by the imaging unit 110, and an image of the article WA is further captured as illustrated in FIG. 4. This enables a great variety of information associated with the measured value to be displayed on the display unit 140 by the display control unit 130 as illustrated in FIG. 5.

For example, images or CAD models of a plurality of types of bolt and nut sets are prepared in advance in the storage unit 160. In addition, in association with each type of bolt and nut set, a design drawing, a measurement procedure drawing, and a design value (specification value) are also stored in the storage unit 160.

Under the condition, the images or the CAD models of the plurality of types of bolt and nut sets are checked against the image of the article WA, and a type of the bolt and nut set can be identified from commonality of features.

In addition, the storage unit 160 can be searched on the basis of the identified type of the bolt and nut set, and a design drawing R3 can be displayed.

Further, the storage unit 160 can be searched on the basis of the type of the bolt and nut set and the captured image IM, and a measurement procedure drawing R4 corresponding and a design value (specification value) R5 can be displayed.

The integrated data generating unit 150 captures an image displayed on the display unit 140 to generate image data and extracts a predetermined portion of the predetermined information as extended information to generate and output integrated data in which the extended information is added to the image data. The extended information to be extracted may be any information determined depending on the purpose of search, providing that the extended information is numerical or character data that can be added to the image data. In addition, a method for adding the extended information to the image data is also any method. For example, a method for storing the extended information in a metadata region provided in an image data file may be adopted, or a method using an electronic watermark in which the extended information is embedded in image data itself in an imperceptible manner for a human, or the like may be adopted.

According to the measurement information integrating device 100 configured as described above, the integrated data including the image data in which the measured value and the information associated with the measured value can be read simultaneously, and the extended information can be generated easily. Accordingly, the measured value in the measurement and the information associated with the measured value can be read easily only by extraction of the integrated data related to the measurement of the target object. In addition, since each piece of the integrated data includes the extended data related to each measurement, information can be accessed and analyzed easily. Further, since the configuration is simple, the measurement information integrating device 100 can be realized at low cost.

### Second Embodiment

A function of each unit of a measurement information integrating device 100 may be realized by describing the function in a program and causing a computer to execute the program.

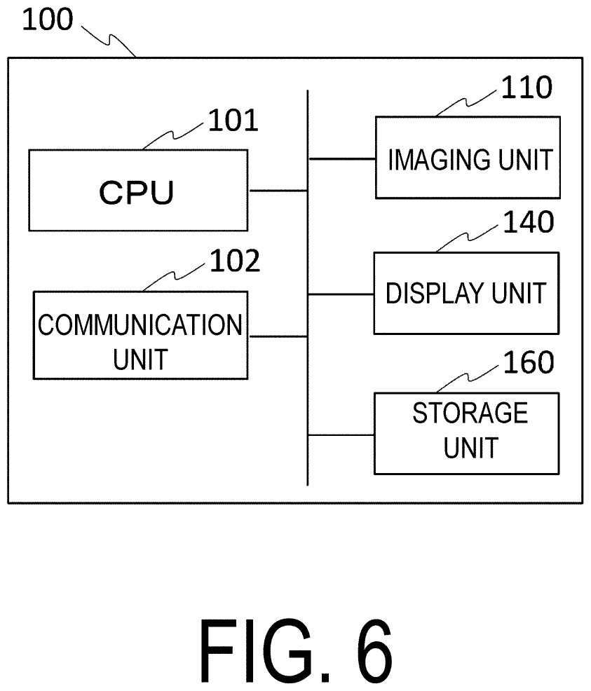

FIG. 6 is a view illustrating an example of a configuration of the measurement information integrating device 100 in a case where a function of each unit is realized by describing the function of each unit in a program and causing a computer to execute the program.

The measurement information integrating device 100 includes a CPU 101, the imaging unit 110, the display unit 140, the storage unit 160, and a communication unit 102, for example.

The CPU 101 executes a program which is stored in the storage unit 160 and in which a function of each unit is described and realizes a function of the measurement information integrating device 100.

The storage unit 160 is any storage unit in which an image of a measuring device, an image of a target object, other information to be displayed on the display unit 140, and a program are stored. For example, a storage medium such as an HDD and a flash memory, and a non-volatile memory, a volatile memory, or the like can be used as the storage unit 160. Note that instead of being provided in the measurement information integrating device 100, the storage unit 160 may be realized by using a cloud storage connected via the communication unit 102. The display unit 140 displays various types of information under control of the CPU 101. The communication unit 102 is an interface for connection with a wireless network or a wired network and transmits and receives, under control of the CPU 101, information to/from a cloud storage or the like connected to a network.

Note that the measurement information integrating device 100 may be configured such that the display unit 140 faces eyes of a wearer in a case where the measurement information integrating device 100 is mounted on a head, and a range of an image captured by the imaging unit changes depending on movement of a body of the wearer. For example, the measurement information integrating device 100 may be configured as a head-mounted display device including a computer, an imaging unit, and a transmissive display. Accordingly, integrated data of a measured value and information associated with the measured value can be generated automatically only by a measurement operation performed by a measurer on which the device is mounted.

The invention is not limited to the embodiments described above. Each embodiment is exemplary, and an embodiment including a configuration substantially identical to the technical ideas set forth in the claims of the invention, and exhibiting similar effects is encompassed by the technical scope of the invention. That is, changes can be made appropriately within the scope of the technical ideas expressed in the invention, and forms in which such changes and modifications are added are also encompassed by the technical scope of the invention.

### REFERENCE SIGNS LIST

100 Measurement information integrating device

101 CPU

102 Communication unit

110 Imaging unit

120 Measured value reading unit

130 Display control unit

140 Display unit

150 Integrated data generating unit

160 Storage unit

D Measured value display unit

IM Captured image

MV Measured value

R1 Measurement date and time information

R2 Model information

R3 Design drawing

R4 Measurement procedure drawing

R5 Design value (specification value)

T Measuring device

W Target object

WA Article

1. A measurement information integrating device comprising:
an imaging unit configured to capture an image including a target object during measurement with a measuring device and the measuring device on which a measured value of the target object is displayed;
a measured value reading unit configured to read the measured value from a captured image captured by the imaging unit;
a display unit;
a display control unit configured to superimpose the measured value and predetermined information associated with the measured value on a periphery of the target object and the measuring device present in the captured image and to cause the display unit to display a superimposed image; and
an integrated data generating unit configured to capture an image displayed on the display unit to generate image data and to extract a predetermined portion of the predetermined information as extended information to generate integrated data in which the extended information is added to the image data.

2. The measurement information integrating device according to claim 1,
wherein the measurement information integrating device is configured such that the display unit faces eyes of a wearer in a case where the measurement information integrating device is mounted on a head, and a range of an image captured by the imaging unit changes depending on movement of a body of the wearer.

3. A program for causing a computer to function as each unit of the measurement information integrating device according to claim 1.
